(19) United States
(12) Patent Application Publication
(10) Pub. No.: US 2025/0294432 A1
(43) Pub. Date: Sep. 18, 2025

(54) TECHNIQUES FOR TRANSMITTING ON-DEMAND SYSTEM INFORMATION

(71) Applicant: Lenovo (United States) Inc., Morrisville, NC (US)

(72) Inventors: Karthikeyan Ganesan, Nauheim (DE); Hyejung Jung, Northbrook, IL (US); Ali Ramadan Ali, Kraiburg am Inn (DE); Ravi Kuchibhotla, Chicago, IL (US)

(21) Appl. No.: 19/221,164

(22) Filed: May 28, 2025

(51) Int. Cl. H04W 48/14

(52) U.S. Cl. CPC H04W 48/14

(57) ABSTRACT

Various aspects of the present disclosure relate to techniques for transmitting on-demand system information. A network equipment (NE) is configured to transmit a first information that configures remaining minimum system information (RMSI), wherein a first part of the RMSI is configured to be transmitted in a master information block (MIB) comprising common control resource set (CORSET) information and common search space monitoring information containing scheduling information associated with a second part of RMSI, and wherein the second part of the RMSI comprises paging resource monitoring information; transmit a second information that configures at least one monitoring occasion in a physical downlink control channel (PDCCH) to transmit a first on-demand system information block (SIB1); and transmit the SIB1 after transmission of a paging message.

### TECHNICAL FIELD

The present disclosure relates to wireless communications, and more specifically to techniques for transmitting on-demand system information.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to receive a first information that configures remaining minimum system information (RMSI), wherein a first part of the RMSI is configured to be received in a master information block (MIB) comprising common control resource set (CORSET) information and common search space monitoring information containing scheduling information associated with a second part of RMSI, and wherein the second part of the RMSI comprises paging resource monitoring information, receive a second information that configures at least one monitoring occasion in a physical downlink control channel (PDCCH) to receive a first on-demand system information block (SIB1), and receive the SIB1 after receiving of a paging message.

A processor for wireless communication is described. The processor may be configured to, capable of, or operable to receive a first information that configures RMSI, wherein a first part of the RMSI is configured to be received in a MIB comprising common CORSET information and common search space monitoring information containing scheduling information associated with a second part of RMSI, and wherein the second part of the RMSI comprises paging resource monitoring information, receive a second information that configures at least one monitoring occasion in a PDCCH to receive a first on-demand SIB1, and receive the SIB1 after receiving of a paging message.

A method for wireless communication performed by a UE is described. The method may be configured to, capable of, or operable to receive a first information that configures RMSI, wherein a first part of the RMSI is configured to be received in a MIB comprising common CORSET information and common search space monitoring information containing scheduling information associated with a second part of RMSI, and wherein the second part of the RMSI comprises paging resource monitoring information, receive a second information that configures at least one monitoring occasion in a PDCCH to receive a first on-demand SIB1, and receive the SIB1 after receiving of a paging message.

An NE for wireless communication is described. The NE may be configured to, capable of, or operable to transmit a first information that configures RMSI, wherein a first part of the RMSI is configured to be transmitted in a MIB comprising common CORSET information and common search space monitoring information containing scheduling information associated with a second part of RMSI, and wherein the second part of the RMSI comprises paging resource monitoring information, transmit a second information that configures at least one monitoring occasion in a PDCCH to transmit a first on-demand SIB1, and transmit the SIB1 after transmission of a paging message.

A processor for wireless communication is described. The processor may be configured to, capable of, or operable to transmit a first information that configures RMSI, wherein a first part of the RMSI is configured to be transmitted in a MIB comprising common CORSET information and common search space monitoring information containing scheduling information associated with a second part of RMSI, and wherein the second part of the RMSI comprises paging resource monitoring information, transmit a second information that configures at least one monitoring occasion in a PDCCH to transmit a first on-demand SIB1, and transmit the SIB1 after transmission of a paging message.

A method for wireless communication performed by a NE is described. The method may be configured to, capable of, or operable to transmit a first information that configures RMSI, wherein a first part of the RMSI is configured to be transmitted in a MIB comprising common CORSET information and common search space monitoring information containing scheduling information associated with a second part of RMSI, and wherein the second part of the RMSI comprises paging resource monitoring information, transmit a second information that configures at least one monitoring occasion in a PDCCH to transmit a first on-demand SIB1, and transmit the SIB1 after transmission of a paging message.

### BRIEF DESCRIPTION OF THE DRAWINGS

FIG. 1 illustrates an example of a wireless communications system, in accordance with aspects of the present disclosure.

FIG. 2 illustrates an example 5G NR initial access procedure, in accordance with aspects of the present disclosure.

FIG. 3 illustrates an example 6G initial access procedure—option 1, in accordance with aspects of the present disclosure.

FIG. 4 illustrates an example of type 0 physical downlink control channel (PDCCH) monitoring window for SIB1, in accordance with aspects of the present disclosure.

FIG. 5 depicts an example 6G initial access procedure—option 2, in accordance with aspects of the present disclosure.

FIG. 6 depicts an example on-demand SIB1 request and indication for mobile originated (MO) traffic, in accordance with aspects of the present disclosure.

FIG. 7 illustrates an example of a UE, in accordance with aspects of the present disclosure.

FIG. 8 illustrates an example of a processor, in accordance with aspects of the present disclosure.

FIG. 9 illustrates an example of an NE, in accordance with aspects of the present disclosure.

FIG. 10 illustrates a flowchart of a method performed by a UE, in accordance with aspects of the present disclosure.

FIG. 11 illustrates a flowchart of a method performed by an NE, in accordance with aspects of the present disclosure.

### DETAILED DESCRIPTION

Generally, the present disclosure describes systems, methods, and apparatuses for techniques for transmitting on-demand system information. In certain examples, the methods may be performed using computer-executable code embedded on a computer-readable medium. In certain examples, an apparatus or system may include a computer-readable medium containing computer-readable code which, when executed by a processor, causes the apparatus or system to perform at least a portion of the below described solutions.

In accordance with examples described herein, a wireless communication system (e.g., a 5G or 6G communication system) may periodically transmit system information in accordance with a predetermined frequency. However, transmitting the system information periodically may be inefficient, time consuming, power consuming, and resource consuming.

Given these disadvantages, the subject matter herein describes solutions that facilitate a reduction in resources needed to transmit system information. By having a certain system information transmitted on-demand, a number of repetitions needed for transmitting system information to a UE may be reduced, thereby reducing power, time, and resources.

Aspects of the present disclosure are described in the context of a wireless communications system. Note that one or more aspects from different solutions may be combined.

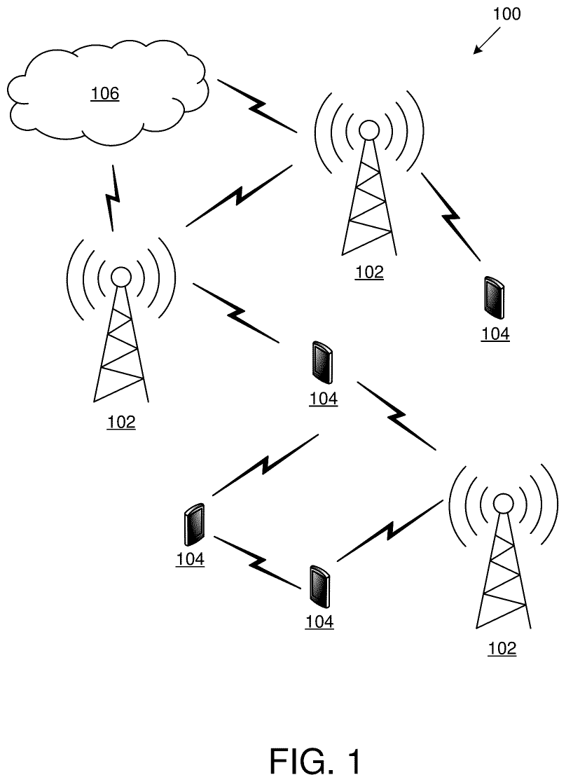

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g.,μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In 6G networks, a principal objective is to reduce overall network energy consumption compared to 5G systems. One key approach to achieving this objective involves reducing the transmission rate of common channels that are utilized during the initial access procedure.

An increase in the periodicity of common channel transmissions may contribute to energy savings but can also result in longer cell detection times. The cell detection time refers to the duration required by a UE to detect the primary synchronization signal (PSS) and secondary synchronization signal (SSS), measure the associated signal quality, and evaluate the cell based on selection quality thresholds. These thresholds are typically broadcast as part of the remaining minimum system information (RMSI), such as in SIB1, in 5G networks.

In 5G, the set of transmission channels used for initial access generally includes the PSS, SSS, physical broadcast channel (PBCH), and CORESET #0, which carries the Type0 physical downlink control channel (PDCCH) common search space (CSS). This configuration enables the UE to acquire system information block 1 (SIB1), which provides parameters such as bandwidth part (BWP) configuration, paging resource configuration, and random access channel (RACH) resource configuration.

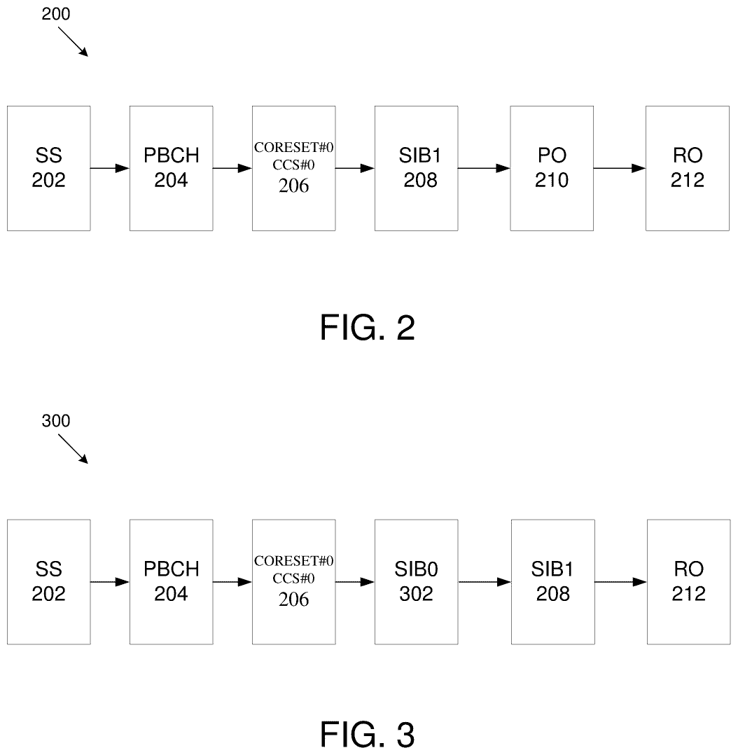

FIGS. 2 illustrates an example 5G NR initial access procedure 200, in accordance with aspects of the present disclosure. The 5G NR initial access procedure 200 includes SS 202, PBCH 204, CORESET #0/CSS #0 206, SIB1 208, paging occasion (PO) 210, and RACH occasion (RO) 212.

Acquisition of SIB1 208 is crucial for enabling a UE to determine available public land mobile networks (PLMNs), interpret cell barring conditions, configure the initial BWP, and apply unified access control mechanisms.

In some 5G NR implementations, an initial access transmission may include a synchronization signal block (SSB), which includes PSS, SSS, and PBCH. CORESET #0 may then provide the scheduling for SIB1 through the Type0-PDCCH CSS. SIB1 may be transmitted at a 20 ms periodicity, although its modification period is 160 ms. Similarly, the PBCH may be transmitted with the SSB at a 20 ms periodicity, while the MIB may have a default modification period of 80 ms.

For 6G NR systems, increasing the periodicity of SSB and SIB1 may help achieve network energy savings. However, this may come at the cost of increased access delay for idle mode UEs attempting to enter the network. To address this trade-off, configurations herein enable SIB1 periodicity to be increased—or for SIB1 to be transmitted on demand—without negatively impacting the access delay for idle UEs.

Increasing the periodicity of SSB and SIB1 may result in delays in a cell selection procedure. This delay may be mitigated by separating the cell selection-related information from the rest of the system information and transmitting it earlier in a separate signaling message. A similar delay may occur in acquiring paging configuration and receiving paging messages when SSB and SIB1 periodicities are increased.

One or more configurations depicted herein provide a mechanism to reduce overall latency associated with cell selection and cell camping by enabling a UE to acquire both paging configuration and cell selection information promptly. Some configurations may correspond to how and when a UE may acquire RMSI, including RACH-related configuration data.

In one embodiment, the network may transmit an optimized version of SIB0 containing only essential information (e.g., a minimum amount of information for operation), thereby enabling the UE to select a cell without experiencing access delay—even in scenarios where SIB1 is transmitted on demand. This approach may support network energy efficiency by reducing unnecessary periodic broadcasts of full SIB1. The master information block (MIB), SIB0, and SIB1 together may comprise the full RMSI needed for cell determination. In this embodiment, the RMSI may be divided into three sequential components. Specifically, the first component is the MIB; the second is SIB0; and the third is an on-demand (OD)-SIB1, which is transmitted only after a paging message is sent by the network. This approach of this embodiment may be motivated by the observation that idle mode UEs generally do not require the complete content of SIB1 to perform cell selection. Much of the information in SIB1—such as RACH configuration, BWP settings, and scheduling of other SIBs—is only needed when the UE transitions to connected mode, either after receiving a paging message for MT traffic or initiating a connection for mobile-originated (MO) traffic. Thus, a streamlined SIB0 may be sufficient for idle mode operation.

In one implementation (e.g., Option 1), the MIB may include configuration parameters for CORESET #0 and CSS #0. These parameters may enable the Type0-PDCCH common search space to schedule the transmission of SIB0, as illustrated in FIG. 3.

At a minimum, SIB0 may contain the following information: cell selection related information, cell access related information, a list of supported services by a cell (e.g., emergency support capability), and/or paging monitoring configuration. An example of a paging monitoring configuration may include: paging cycle (aligned with idle mode DRX cycle): 2-3 bits; number of paging frames within a DRX cycle: 3-4 bits; number of paging occasions within a paging frame: 2-3 bits; and/or PCCH-Config structure: 7-10 bits.

Specifically, FIG. 3 illustrates an example 6G initial access procedure 300—option 1, in accordance with aspects of the present disclosure. FIG. 3 includes some features previously included in FIG. 2 as well as SIB0 302. The embodiment illustrated in FIG. 3 may address how idle mode UEs may acquire PDCCH scheduling information for OD-SIB1 and a related procedure.

In FIG. 3, SIB0 302 may provide the paging monitoring configuration, while OD-SIB1 may be transmitted by the base station only in response to a paging event. The presence of OD-SIB1 may be signaled in various ways, including: paging DCI; early paging indicator; and/or low-power wake-up signals or paging-specific signaling.

A configuration for CSS monitoring within CORESET #0 may be used to enable UEs to receive OD-SIB1 following paging. This monitoring configuration may be transmitted as part of the MIB or SIB0 302. In some implementations, a separate CSS for SIB1 208 may not be configured; instead, the UE may reuse the CSS #0 configuration initially used for SIB0 302 acquisition.

The starting time and duration for monitoring PDCCH for SIB1 208 scheduling may be either predefined or signaled dynamically. The monitoring window may be referenced from the last paging occasion in a paging frame. In various implementations, the PDCCH monitoring window may be determined based on a paging frame; a specific paging occasion; and/or the PDCCH monitoring occasion used for paging DCI detection. SIB1 208 may include RACH-related configuration, enabling the UE to initiate a random access procedure following a successful paging message.

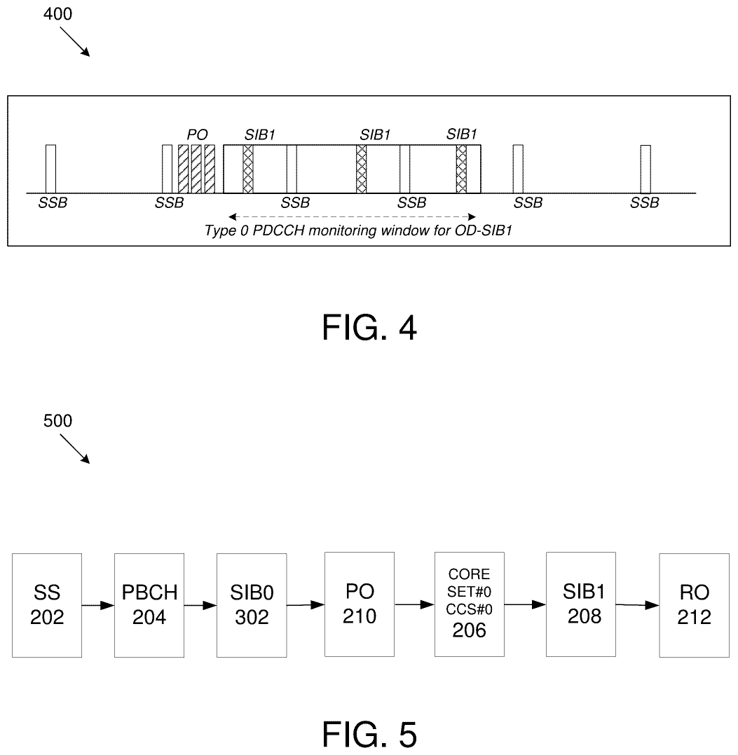

FIG. 4 illustrates an example 400 of type 0 physical downlink control channel (PDCCH) monitoring window for SIB1, in accordance with aspects of the present disclosure. As illustrated, POs occur before the PDCCH monitoring window. During the PDCCH monitoring window, there are multiple SIB1 and SSB shown.

FIG. 5 depicts an example 6G initial access procedure 500—option 2, in accordance with aspects of the present disclosure. FIG. 5 includes some features previously included in FIGS. 2 and 3.

As illustrated in FIG. 5, the MIB may include scheduling information for SIB0. In this configuration, SIB0 may carry the configuration parameters for CORESET #0 and the CSS #0, while the Type 0 PDCCH used for scheduling SIB1 may be configured as shown in FIG. 5.

At a minimum, SIB0 may include the following content: cell selection related information, cell access related information, an indication of services supported by the cell (e.g., including emergency support), and a paging monitoring related configuration.

This embodiment further includes a procedure by which an idle mode UE may acquire PDCCH information used to schedule the transmission of SIB1. Specifically, SIB0 may provide the configuration for paging monitoring, while SIB1 may be transmitted by the base station only after a paging message has been sent. The Type 0 PDCCH monitoring occasion, located within CORESET #0 and used to enable the UE to receive SIB1 after paging, may be configured and transmitted as part of SIB0.

The starting time and duration of the monitoring window for PDCCH carrying SIB1 scheduling information may be indicated in the DCI used for paging, or signaled explicitly within SIB0. The reference time for determining the start of this monitoring window may be based on the last paging reception slot within a paging frame, as illustrated in the accompanying figure. SIB1 may include RACH configuration parameters, enabling the UE to initiate RACH procedures following successful paging.

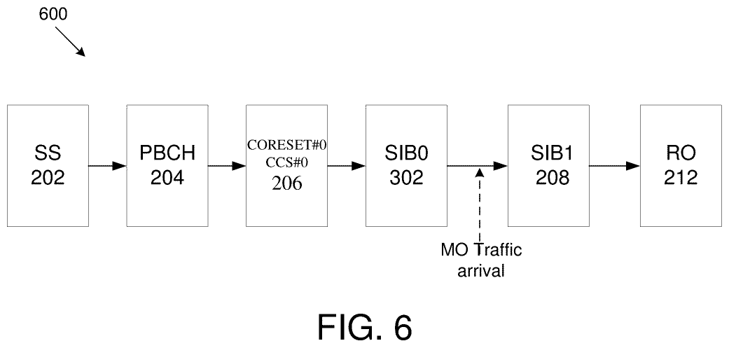

According to a second embodiment, the UE may be configured—via SIB0—to include a dedicated field that specifies a new CSS monitoring configuration. This configuration enables the UE to monitor a PDCCH carrying system information using a system information radio network temporary identifier (SI-RNTI) within CORESET #0. An additional field may be provided either in the DCI that schedules SIB0 or within SIB0 itself, indicating whether or not SIB1 is being transmitted during the current monitoring window. This configuration is reflected in FIGS. 3 and 6.

When SIB0 indicates the presence of an upcoming SIB1 transmission, the UE may begin monitoring PDCCH according to the configured search space. Conversely, if SIB0 indicates that no SIB1 is scheduled, the UE may skip monitoring for SIB1, thereby conserving power. Such indication may be provided via a value within a modificationPeriodCoeff field or an equivalent signaling mechanism.

FIG. 6 depicts an example on-demand SIB1 request and indication for mobile originated (MO) traffic 600, in accordance with aspects of the present disclosure. FIG. 6 includes some features previously included in FIGS. 2 and 3.

In low-load scenarios—such as when relatively few new UEs are entering the cell or when most UEs remain in idle mode—OD-SIB1 transmission may be initiated using an uplink wake-up signal (UL WUS) request.

The UL WUS configuration may be provided through various mechanisms depending on the network deployment and UE capabilities. For instance, UL WUS resources may be preconfigured by the home public land mobile network (H-PLMN) during the UE's initial registration with the network. Additionally, the configuration may be defined on a per-cell or per-frequency band basis or restored from information previously stored by the UE. In some implementations, multiple preconfigured UL WUS configurations may be made available to the UE either through H-PLMN provisioning or from stored parameters. In such cases, SIB0 may include an index or identifier referencing the specific parameter set to be activated for UL WUS operation.

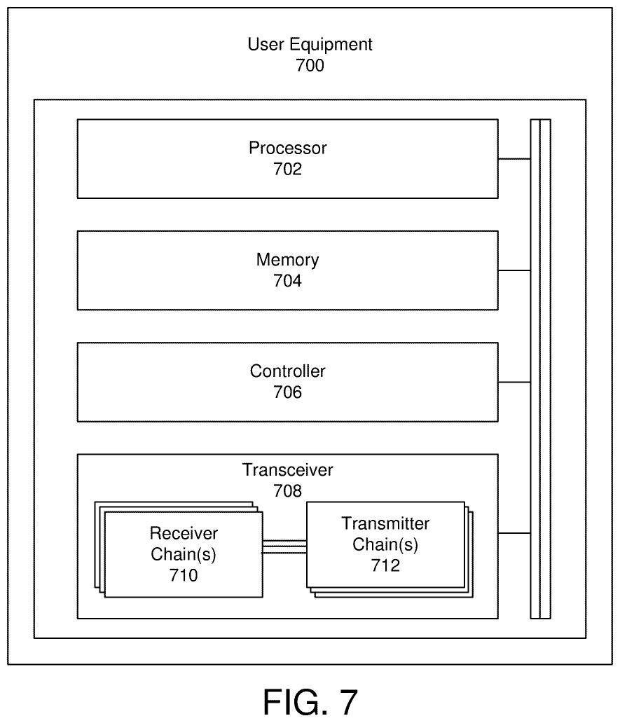

FIG. 7 illustrates an example of a UE 700 in accordance with aspects of the present disclosure. The UE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a central processing unit (CPU), an ASIC, a field programmable gate array (FPGA), or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the UE 700 to perform various functions of the present disclosure.

The memory 704 may include volatile or non-volatile memory. The memory 704 may store computer-readable, computer-executable code including instructions that, when executed by the processor 702, cause the UE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the UE 700 to perform one or more of the UE functions described herein (e.g., executing, by the processor 702, instructions stored in the memory 704). Accordingly, the processor 702 may support wireless communication at the UE 700 in accordance with examples as disclosed herein.

In one example, the UE 700 is configured to receive a first information that configures RMSI, wherein a first part of the RMSI is configured to be received in a MIB comprising common CORSET information and common search space monitoring information containing scheduling information associated with a second part of RMSI, and wherein the second part of the RMSI comprises paging resource monitoring information, receive a second information that configures at least one monitoring occasion in a PDCCH to receive a first on-demand SIB1, and receive the SIB1 after receiving of a paging message.

The controller 706 may manage input and output signals for the UE 700. The controller 706 may also manage peripherals not integrated into the UE 700. In some implementations, the controller 706 may utilize an operating system (OS) such as iOS®, ANDROID®, WINDOWS®, or other operating systems. In some implementations, the controller 706 may be implemented as part of the processor 702.

In some implementations, the UE 700 may include at least one transceiver 708. In some other implementations, the UE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for decoding/processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

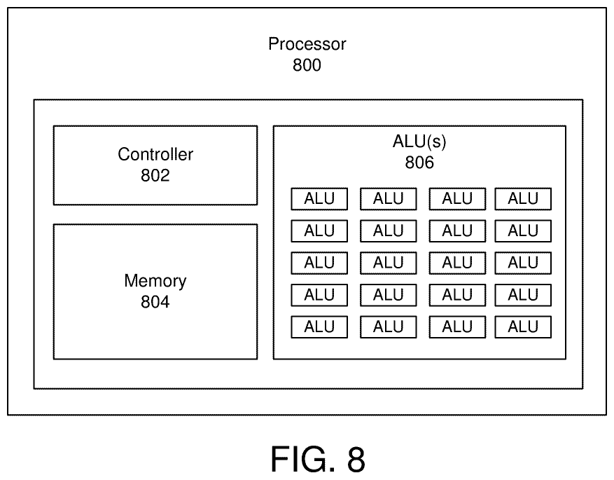

FIG. 8 illustrates an example of a processor 800 in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804, which may be, for example, an L1/L2/L3 cache. Additionally, or alternatively, the processor 800 may optionally include one or more arithmetic-logic units (ALUs) 806. One or more of these components may be in electronic communication or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementations, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions. For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 806 may be configured to support various operations in accordance with examples as described herein. In some implementations, the one or more ALUs 806 may reside within or on a processor chipset (e.g., the processor 800). In some other implementations, the one or more ALUs 806 may reside external to the processor chipset (e.g., the processor 800). One or more ALUs 806 may perform one or more computations such as addition, subtraction, multiplication, and division on data. For example, one or more ALUs 806 may receive input operands and an operation code, which determines an operation to be executed. One or more ALUs 806 be configured with a variety of logical and arithmetic circuits, including adders, subtractors, shifters, and logic gates, to process and manipulate the data according to the operation. Additionally, or alternatively, the one or more ALUs 806 may support logical operations such as AND, OR, exclusive-OR (XOR), not-OR (NOR), and not-AND (NAND), enabling the one or more ALUs 806 to handle conditional operations, comparisons, and bitwise operations.

In various examples, the processor 800 may support wireless communication of a UE, in accordance with examples as disclosed herein. In other examples, the processor 800 may support wireless communication of a RAN entity, in accordance with examples as disclosed herein.

In one example, a processor 800 is configured to receive a first information that configures RMSI, wherein a first part of the RMSI is configured to be received in a MIB comprising common CORSET information and common search space monitoring information containing scheduling information associated with a second part of RMSI, and wherein the second part of the RMSI comprises paging resource monitoring information, receive a second information that configures at least one monitoring occasion in a PDCCH to receive a first on-demand SIB1, and receive the SIB1 after receiving of a paging message.

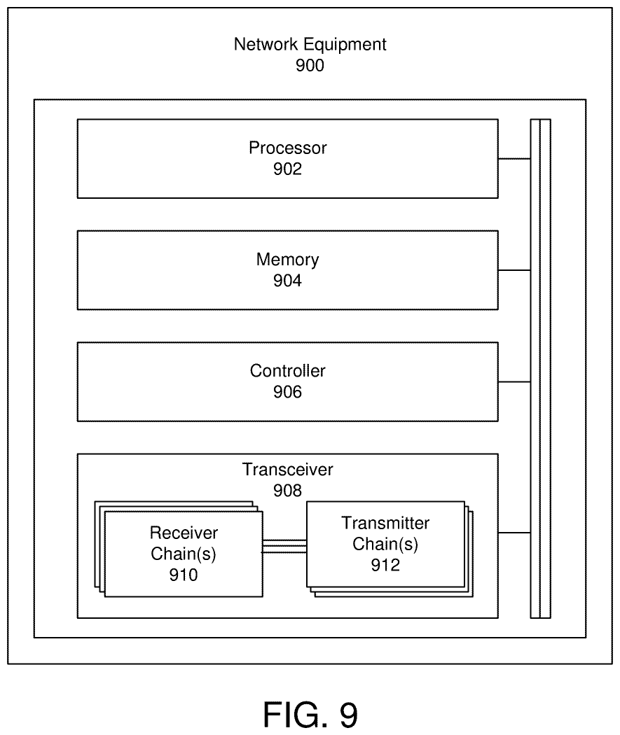

FIG. 9 illustrates an example of a NE 900 in accordance with aspects of the present disclosure. The NE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the NE 900 to perform various functions of the present disclosure.

The memory 904 may include volatile or non-volatile memory. The memory 904 may store computer-readable, computer-executable code including instructions when executed by the processor 902 cause the NE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the NE 900 to perform one or more of the RAN functions described herein (e.g., executing, by the processor 902, instructions stored in the memory 904). For example, the processor 902 may support wireless communication at the NE 900 in accordance with examples as disclosed herein.

In one example, a NE 900 is configured to transmit a first information that configures RMSI, wherein a first part of the RMSI is configured to be transmitted in a MIB comprising common CORSET information and common search space monitoring information containing scheduling information associated with a second part of RMSI, and wherein the second part of the RMSI comprises paging resource monitoring information, transmit a second information that configures at least one monitoring occasion in a PDCCH to transmit a first on-demand SIB1, and transmit the SIB1 after transmission of a paging message.

The controller 906 may manage input and output signals for the NE 900. The controller 906 may also manage peripherals not integrated into the NE 900. In some implementations, the controller 906 may utilize an operating system such as iOS®, ANDROID®, WINDOWS®, or other operating systems. In some implementations, the controller 906 may be implemented as part of the processor 902.

In some implementations, the NE 900 may include at least one transceiver 908. In some other implementations, the NE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receiving the signal over the air or wireless medium. The receiver chain 910 may include at least one amplifier (e.g., a low-noise amplifier (LNA)) configured to amplify the received signal. The receiver chain 910 may include at least one demodulator configured to demodulate the received signal and obtain the transmitted data by reversing the modulation technique applied during transmission of the signal. The receiver chain 910 may include at least one decoder for decoding/processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

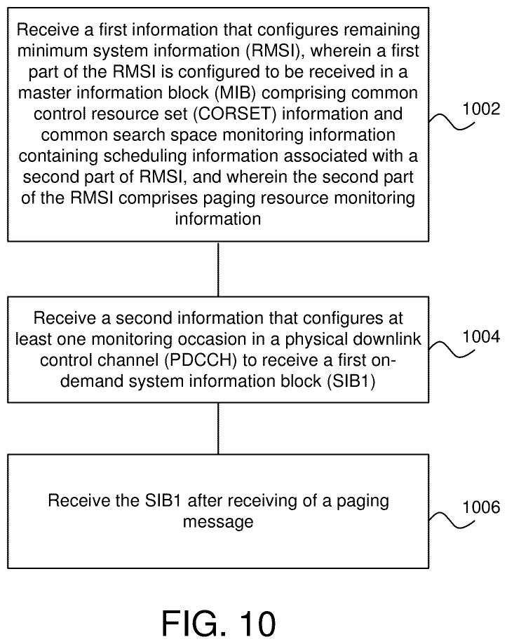

FIG. 10 illustrates a flowchart of a method performed by a UE 700 in accordance with aspects of the present disclosure. The operations of the method may be implemented by a UE 700 as described herein. In some implementations, the UE 700 may execute a set of instructions to control the function elements of the UE 700 to perform the described functions.

At step 1002, the method may receive a first information that configures RMSI, wherein a first part of the RMSI is configured to be received in a MIB comprising common CORSET information and common search space monitoring information containing scheduling information associated with a second part of RMSI, and wherein the second part of the RMSI comprises paging resource monitoring information. The operations of step 1002 may be performed in accordance with examples as described herein. In some implementations, aspects of the operations of step 1002 may be performed by a UE 700, as described with reference to FIG. 7.

At step 1004, the method may receive a second information that configures at least one monitoring occasion in a PDCCH to receive a first on-demand SIB1. The operations of step 1004 may be performed in accordance with examples as described herein. In some implementations, aspects of the operations of step 1004 may be performed by a UE 700, as described with reference to FIG. 7.

At step 1006, the method may receive the SIB1 after receiving of a paging message. The operations of step 1006 may be performed in accordance with examples as described herein. In some implementations, aspects of the operations of step 1006 may be performed by a UE 700, as described with reference to FIG. 7.

It should be noted that the method described herein describes one possible implementation, and that the operations and the steps may be rearranged or otherwise modified and that other implementations are possible.

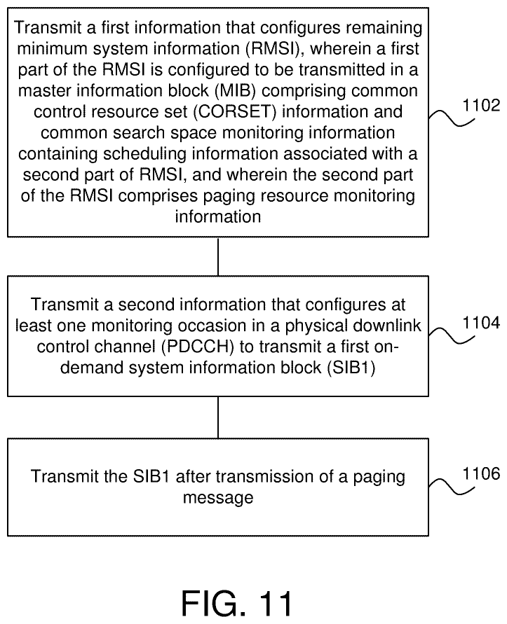

FIG. 11 illustrates a flowchart of a method performed by an NE 900 in accordance with aspects of the present disclosure. The operations of the method may be implemented by a NE 900 as described herein. In some implementations, the NE 900 may execute a set of instructions to control the function elements of the NE 900 to perform the described functions.

At step 1102, the method may transmit a first information that configures RMSI, wherein a first part of the RMSI is configured to be transmitted in a MIB comprising common CORSET information and common search space monitoring information containing scheduling information associated with a second part of RMSI, and wherein the second part of the RMSI comprises paging resource monitoring information. The operations of step 1102 may be performed in accordance with examples as described herein. In some implementations, aspects of the operations of step 1102 may be performed by a NE 900, as described with reference to FIG. 9.

At step 1104, the method may transmit a second information that configures at least one monitoring occasion in a PDCCH to transmit a first on-demand SIB1. The operations of step 1104 may be performed in accordance with examples as described herein. In some implementations, aspects of the operations of step 1104 may be performed by a NE 900, as described with reference to FIG. 9.

At step 1106, the method may transmit the SIB1 after transmission of a paging message. The operations of step 1106 may be performed in accordance with examples as described herein. In some implementations, aspects of the operations of step 1106 may be performed by a NE 900, as described with reference to FIG. 9.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A base station, comprising:
at least one memory; and
at least one processor coupled with the at least one memory and configured to cause the base station to:
transmit a first information that configures remaining minimum system information (RMSI), wherein a first part of the RMSI is configured to be transmitted in a master information block (MIB) comprising common control resource set (CORSET) information and common search space monitoring information containing scheduling information associated with a second part of RMSI, and wherein the second part of the RMSI comprises paging resource monitoring information;
transmit a second information that configures at least one monitoring occasion in a physical downlink control channel (PDCCH) to transmit a first on-demand system information block (SIB1); and
transmit the SIB1 after transmission of a paging message.

2. The base station of claim 1, wherein the at least one monitoring occasion is signaled within the first part of the RMSI or the second part of the RMSI.

3. The base station of claim 1, wherein the paging resource monitoring information comprises a paging cycle.

4. The base station of claim 3, wherein the paging cycle comprises an idle mode discontinuous reception (DRX) cycle.

5. The base station of claim 4, wherein the paging resource monitoring information comprises a number of paging frames within the idle mode DRX cycle.

6. The base station of claim 1, wherein the paging resource monitoring information comprises a number of paging occasions in a paging frame.

7. The base station of claim 1, wherein the second part of the RMSI further comprises cell selection information and cell access related information.

8. The base station of claim 1, wherein a third part of the RMSI comprises the SIB1 which comprises at least a random access resource and serving cell information containing an initial bandwidth part configuration.

9. A user equipment (UE), comprising:
at least one memory; and
at least one processor coupled with the at least one memory and configured to cause the UE to:
receive a first information that configures remaining minimum system information (RMSI), wherein a first part of the RMSI is configured to be received in a master information block (MIB) comprising common control resource set (CORSET) information and common search space monitoring information containing scheduling information associated with a second part of RMSI, and wherein the second part of the RMSI comprises paging resource monitoring information;
receive a second information that configures at least one monitoring occasion in a physical downlink control channel (PDCCH) to receive a first on-demand system information block (SIB1); and
receive the SIB 1 after receiving of a paging message.

10. The UE of claim 9, wherein the at least one monitoring occasion is signaled within the first part of the RMSI or the second part of the RMSI.

11. The UE of claim 9, wherein the paging resource monitoring information comprises a paging cycle.

12. The UE of claim 11, wherein the paging cycle comprises an idle mode discontinuous reception (DRX) cycle.

13. The UE of claim 12, wherein the paging resource monitoring information comprises a number of paging frames within the idle mode DRX cycle.

14. The UE of claim 9, wherein the paging resource monitoring information comprises a number of paging occasions in a paging frame.

15. The UE of claim 9, wherein the second part of the RMSI further comprises cell selection information and cell access related information.

16. The UE of claim 9, wherein a third part of the RMSI comprises the SIB1 which comprises at least a random access resource and serving cell information containing an initial bandwidth part configuration.

17. A processor for wireless communication, comprising:
at least one controller coupled with at least one memory and configured to cause the processor to:
receive a first information that configures remaining minimum system information (RMSI), wherein a first part of the RMSI is configured to be received in a master information block (MIB) comprising common control resource set (CORSET) information and common search space monitoring information containing scheduling information associated with a second part of RMSI, and wherein the second part of the RMSI comprises paging resource monitoring information;
receive a second information that configures at least one monitoring occasion in a physical downlink control channel (PDCCH) to receive a first on-demand system information block (SIB1); and
receive the SIB1 after receiving of a paging message.

18. A method performed by a user equipment (UE), the method comprising:
receiving a first information that configures remaining minimum system information (RMSI), wherein a first part of the RMSI is configured to be received in a master information block (MIB) comprising common control resource set (CORSET) information and common search space monitoring information containing scheduling information associated with a second part of RMSI, and wherein the second part of the RMSI comprises paging resource monitoring information;
receiving a second information that configures at least one monitoring occasion in a physical downlink control channel (PDCCH) to receive a first on-demand system information block (SIB1); and
receiving the SIB1 after receiving of a paging message.

19. The method of claim 18, wherein the at least one monitoring occasion is signaled within the first part of the RMSI or the second part of the RMSI.

20. The method of claim 18, wherein the paging resource monitoring information comprises a paging cycle.
